(19) United States
(12) Patent Application Publication
(10) Pub. No.: US 2025/0251096 A1
(43) Pub. Date: Aug. 7, 2025

(54) QUICK VENTING OF FUEL STORAGE SYSTEM FOR VEHICLE

(71) Applicant: The Heil Co., Chattanooga, TN (US)

(72) Inventor: Nitesh S. Shroff, Chattanooga, TN (US)

(21) Appl. No.: 19/038,035

(22) Filed: Jan. 27, 2025

Related U.S. Application Data
(60) Provisional application No. 63/550,230, filed on Feb. 6, 2024.

(51) Int. Cl. F17C 13/12

(52) U.S. Cl. CPC F17C 13/123; F17C 2205/013; F17C 2205/0326; F17C 2205/0332; F17C 2221/033; F17C 2250/032; F17C 2250/043; F17C 2250/0443; F17C 2250/0447; F17C 2260/04; F17C 2270/0171

(57) ABSTRACT

A method of protecting a refuse collection vehicle from damage includes detecting a condition associated with a thermal event on the refuse collection vehicle. In response to detecting the condition associated with the thermal event on the refuse collection vehicle, one or more pressure relief devices coupled to one or more fuel tanks are bypassed such that gas from is vented from the fuel tanks.

### CROSS-REFERENCE TO RELATED APPLICATION

This application claims the benefit under 35 U.S.C. § 119 (e) of U.S. Patent Application No. 63/550,230, entitled “Quick Venting of Fuel Storage System for Vehicle,” filed Feb. 6, 2024, which is incorporated herein by reference in its entirety.

### BACKGROUND

Refuse collection vehicles can be powered by a number of different fuels. These fuels include gasoline, diesel, liquid natural gas (LNG), and compressed natural gas (CNG) fuels. With the uncertainty and rising costs of gasoline and diesel, as well as the stabilization in manufacturing CNG vehicle fuel systems, it has become more desirable to outfit refuse collection vehicles with CNG to run internal combustion engines.

To operate vehicles using CNG, several safety requirements and application standards dictated by applicable governmental and industrial standards must be met. Some of these safety requirements relate to mitigation of risk associated with a fire or other thermal events in or on the vehicle.

### SUMMARY

Implementations of the present disclosure are generally directed to fuel systems for refuse collection vehicles and methods of operating and protecting such fuel systems from fire and other thermal events.

In one general aspect of the disclosure, a method of protecting a refuse collection vehicle from damage includes detecting a condition associated with a thermal event on the refuse collection vehicle, and, in response to detecting the condition associated with the thermal event on the refuse collection vehicle, bypassing one or more pressure relief devices coupled to one or more fuel tanks of the refuse collection vehicle such that gas from at least one of the fuel tanks is vented from the at least one fuel tank.

In some implementations, the gas vented from the at least one fuel tank includes compressed natural gas (CNG).

In some implementations, the condition includes activation of a pressure relief device coupled to one or more of the one or more fuel tanks.

In some implementations, the condition associated with the thermal event includes venting from at least one of the one or more fuel tanks.

In some implementations, the condition associated with the thermal event includes a pressure drop in a vent line in fluid communication with at least one pressure relief device.

In some implementations, the condition associated with the thermal event includes a change in flow rate in a vent line in fluid communication with at least one pressure relief device.

In some implementations, the condition associated with the thermal event includes an increased risk of fire on the refuse collection vehicle.

In some implementations, the thermal event includes a fire on the refuse collection vehicle.

In some implementations, bypassing the one or more pressure relief devices coupled to the one or more fuel tanks includes bypassing two or more pressure relief valves each coupled to a different one of two or more fuel tanks.

In some implementations, the condition associated with the thermal event includes activation of a first pressure relief device coupled to a first one or more of the one or more fuel tanks. Bypassing the one or more pressure relief devices coupled of the one or more fuel tanks includes bypassing one or more un-activated pressure relief devices coupled to the one or more fuel tanks.

In some implementations, the first one of the fuel tanks is the bottom-most one of the fuel tanks in a group of two or more fuel tanks on the refuse collection vehicle.

In some implementations, the first one of the fuel tanks is in the most hazardous location in a group of two or more tanks.

In some implementations, bypassing one or more pressure relief devices coupled to one or more fuel tanks of the refuse collection vehicle includes receiving a signal from an operator to open one or more bypass valves.

In another general aspect of the disclosure, a fuel system for a refuse collection vehicle includes two or more fuel tanks coupled to the refuse collection vehicle, two or more pressure relief devices, one or more pressure relief device bypass valves, one or more sensors, and a processor. Each of at least two of the pressure relief devices is coupled to one or more of the two or more fuel tanks. The processor is coupled to at least one of the one or more sensors and at least one of the one or more pressure relief device bypass valves. The processor is configured to perform operations including, detecting a condition associated with a thermal event on the refuse collection vehicle; and in response to detecting the condition associated with a thermal event on the refuse collection vehicle, bypassing at least one of the one or more pressure relief devices such that gas from at least one of the fuel tanks is vented from the at least one fuel tank.

In some implementations, bypassing at least one of the one or more pressure relief devices includes at least partially opening at least one of the pressure relief device bypass valves.

In another general aspect of the disclosure, a fuel system for a refuse collection vehicle includes two or more fuel tanks coupled to the refuse collection vehicle, two or more pressure relief devices, and one or more pressure relief device bypass valves. Each of at least one of the pressure relief devices is coupled to at least one of the two or more fuel tanks. The one or more pressure relief device bypass valves are fluidly coupled to at least one of the two or more fuel tanks. At least one of the pressure relief device bypass valves is operable to at least partially open such that fuel is vented from at least one of the two or more fuel tanks.

In some implementations, at least one of the pressure relief devices is configured to provide pressure relief to at least two of the two or more fuel tanks.

In some implementations, the fuel system further includes a vent line coupled to at least one of the pressure relief device bypass valves.

In some implementations, the two or more fuel tanks contains compressed natural gas (CNG).

In some implementations, the at least one pressure relief device bypass valve is configured to allow gas to bypass a pressure relief device coupled to each of at least one of the two or more fuel tanks.

In some implementations, the at least one pressure relief device bypass valve is configured to allow gas to bypass a pressure relief device coupled to each of at least two of the two or more fuel tanks.

In some implementations, the at least one pressure relief device bypass valve includes a solenoid valve.

In some implementations, the fuel system further includes a processor configured to at least partially open at least one of the pressure relief device bypass valves in response to detecting a thermal event on the vehicle.

In some implementations, the fuel system further includes one or more sensors on the refuse collection vehicle; and a processor communicatively coupled to at least one of the one or more sensors and at least one of the one or more pressure relief device bypass valves. The processor is configured to perform operations including, in response to receiving data from the at least one sensor, opening at least one of the pressure relief device bypass valves.

In some implementations, the processor is configured to perform operations including, based at least in part on data from the at least one sensor, determine that at least one of the pressure relief devices has activated. The at least one pressure relief device bypass valve is at least partially opened in response to determining that the least one pressure relief device has activated.

In some implementations, at least one of the sensors includes a pressure sensor. The processor is configured to, based at least in part on data from the pressure sensor, determine that a pressure drop meeting predetermined criteria has occurred in at least one line in the fuel system. At least one pressure relief device bypass valve is at least partially opened in response to determining that the pressure drop in the at least one line.

In some implementations, at least one of the sensors includes a flow sensor. The processor is configured to perform operations including, based at least in part on data from the flow sensor, determining that at least one change in flow rate has occurred in at least one line in the fuel system. The at least one pressure relief device bypass valve is at least partially opened in response to determining the at least one flow rate change in the at least one line.

In some implementations, the processor is configured to detect one or more conditions associated with a thermal event on the refuse collection vehicle. The at least one pressure relief device bypass valve is opened in response to detection of at least one of the one or more conditions associated with the thermal event.

In some implementations, the at least one condition includes activation of at least one of the pressure relief devices.

In some implementations, the thermal event includes a fire on the refuse collection vehicle.

In some implementations, the one or more sensors include a flow sensor configured to sense flow in one or more vent lines.

In some implementations, the one or more sensors include a pressure sensor configured to sense pressure in one or more vent lines.

In some implementations, the two or more pressure relief devices include one or more curb-side pressure relief devices and one or more street-side pressure relief devices coupled to at least one of the two or more fuel tanks.

In some implementations, the fuel system further includes a manual control device coupled to at least one of the one or more pressure relief device bypass valves. The manual control device is operable by a user to open the at least one pressure relief device bypass valve such that fuel bypasses at least one of the one or more one or more pressure relief devices.

In some implementations, the fuel system further includes a tank valve assembly coupled to at least one of the two or more tanks, the tank valve assembly including one or more live ports. At least one of the pressure relief device bypass valves is fluidly coupled to at least one of the live ports of the tank valve assembly.

In some implementations, the fuel system further includes a tank valve assembly coupled to at least one of the two or more tanks. The tank valve assembly includes a shutoff valve including one or more live ports. At least one of the pressure relief device bypass valves is fluidly coupled to at least one of the live ports of the shutoff valve.

In some implementations, the fuel system further includes a tank valve assembly coupled to at least one of the two or more tanks. The tank valve assembly includes one or more live ports, and one or more tee fittings. A first branch of the tee fitting is connected to at least one of the live ports. A second branch of the tee fitting is connected to at least one of the pressure relief device bypass valves.

Particular implementations of the subject matter described in this specification can be implemented so as to realize one or more of the following advantages.

Implementations of the present disclosure may decrease the time that fuel tanks in a fire must survive.

Implementations of the present disclosure may reduce risk of damage to fuel tanks or and other vehicle components.

Implementations of the present disclosure may reduce the risk of fuel tanks rupturing.

Implementations of the present disclosure may prevent damage to fuel tanks situated away from where a thermal event occurs.

Implementations of the present disclosure may prevent loss of fuel due to ruptured or damaged tanks.

Implementations of the present disclosure may provide information for earlier intervention and corrective action when a thermal event occurs on a vehicle.

Implementations of the present disclosure may reduce risk of a catastrophic explosion.

Implementations of the present disclosure may reduce risk to life and property.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 illustrates a refuse collection vehicle on which systems and methods as described herein can be implemented.

FIG. 2 is a perspective view of a tailgate including tanks of a fuel storage system with a cover removed according to some implementations.

FIG. 3 is a perspective view illustrating a tank valve assembly on a tank of a fuel storage system.

FIG. 4 is a schematic illustrating a fuel storage system including pressure relief device bypass according to some implementations.

FIG. 5 illustrates a fuel storage system that provides for bypass venting of multiple fuel tanks according to some implementations.

FIG. 6 illustrates a fuel storage system that provides for bypass venting of fuel tanks on both sides of a vehicle according to some implementations.

FIG. 7 is a schematic diagram illustrating a tank valve assembly including a PRD bypass according to some implementations.

FIG. 8 illustrates a refuse collection vehicle with a fuel storage system with PRD bypass system mounted on a cab of a refuse collection vehicle according to some implementations.

FIG. 9 illustrates a refuse collection vehicle with a fuel storage system with PRD bypass system mounted on the front of a body of a refuse collection vehicle according to some implementations.

FIG. 10 illustrates a refuse collection vehicle with a fuel storage system with PRD bypass system mounted on the roof of the body of a refuse collection vehicle according to some implementations.

FIG. 11 illustrates a refuse collection vehicle with a fuel storage system with PRD bypass system mounted on a mount rail according to some implementations.

FIG. 12 depicts an example computing system, according to implementations of the present disclosure.

### DETAILED DESCRIPTION

Implementations of the present disclosure are directed to fuel systems for refuse collection vehicles and methods of operating and protecting such fuel systems from damage and from hazardous operating conditions.

Material inside the body of a refuse collection vehicle can catch fire. An explosion can occur if the fire ignites the compressed natural gas on the waste collection vehicle in its compressed state. In various implementations, pressure relief devices, in response to a predetermined amount of heat, actuate to release the CNG stored in the tanks on the vehicle, venting the gas to the atmosphere outside of the vehicle. If the pressure relief devices fail or are not actuated in an emergency, however, then the CNG within the storage tanks could ignite and explode.

In fuel storage systems with multiple tanks, the temperatures of pressure relief devices on tanks away from a localized fire may not activate. In some cases, the time for a system to vent out gas from all tanks completely may be prolonged.

In various implementations, a fuel storage system on a refuse collection vehicle includes multiple tanks. Each tank can include one or more pressure relief devices. The system can include one or more venting systems that bypass some or all of the pressure relief devices when a thermal event occurs on the refuse collection vehicle. In some implementations, a bypass venting system is activated to bypass pressure relief devices for multiple tanks on a fuel storage system upon detection of activation of a pressure relief device in one of the tanks in the system.

In some implementations, a method of protecting a refuse collection vehicle from damage includes detecting a condition associated with a thermal event on the refuse collection vehicle. In response to detecting the condition, one or more pressure relief devices coupled to one or more fuel tanks are bypassed such that gas from at least one of the fuel tanks is vented from the fuel tanks. In certain implementations, in response to one of the pressure relief valves activating to relieve pressure in one of the fuel tanks, all of the un-activated pressure relief devices in the fuel system are bypassed. In some instances, activation is detected from a sudden pressure drop in a line coupled to the activated pressure relief device. Bypassing pressure relief devices may significantly reduce vent time for the system.

Implementations can be employed with respect to any suitable type of RCV, with any suitable type of body and/or hopper variants. For example, the RCV can be an automated side loader vehicle. As another example, the RCV can be a commercial front loader (e.g., for dumpster type containers. As another example, the RCV can be a residential front loader. A front loader can be provided with or without an intermediate collection device. The intermediate collection device can be used, for example, to collect residential-sized containers.

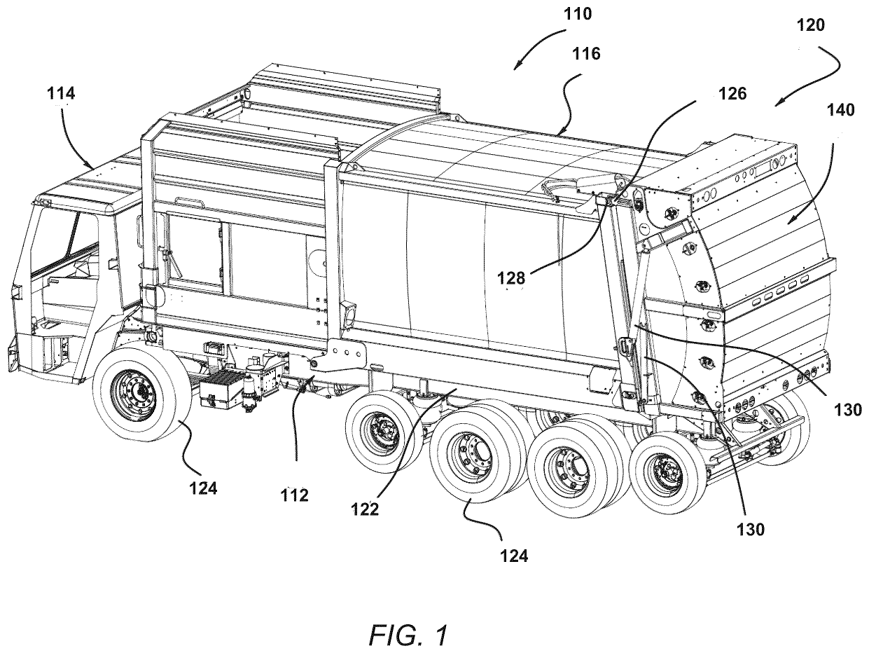

FIG. 1 illustrates a refuse collection vehicle on which systems and methods as described herein can be implemented. Refuse collection vehicle 110 includes a chassis 112 with a cab 114, a refuse container 116 and tailgate 120. The chassis 112 includes a frame 122 that receives the refuse container 116 as well as wheels 124 connected with a drive train that provides mobility of the vehicle.

The tailgate 120 is secured to the refuse container 116 of refuse collection vehicle 110 by way of hinges 126. The hinges 126 are connected around pivot pins 128 so that the tailgate 120 can rotate with respect to the container 116.

In order to rotate, a pair of lift cylinders 130 is on each side of the tailgate 120. The lift cylinders 130 are coupled with the tailgate so that, for opening of the container 116, the lift cylinders 130 are actuated which, in turn, pivots the tailgate 120 about the pivot pins 128 via the hinges 126.

Refuse collection vehicle 110 can be an RCV that operates to collect and transport refuse (e.g., garbage). The refuse collection vehicle can also be described as a garbage collection vehicle, or garbage truck. Refuse collection vehicle 110 can be configured to lift containers that contain refuse and empty the refuse in the containers into a hopper of the refuse collection vehicle 110 and/or intermediate collection device conveyed by the RCV, to enable transport of the refuse to a collection site, compacting of the refuse, and/or other refuse handling activities. Refuse vehicle 100 can also handle containers in other ways, such as by transporting the containers to another site for emptying.

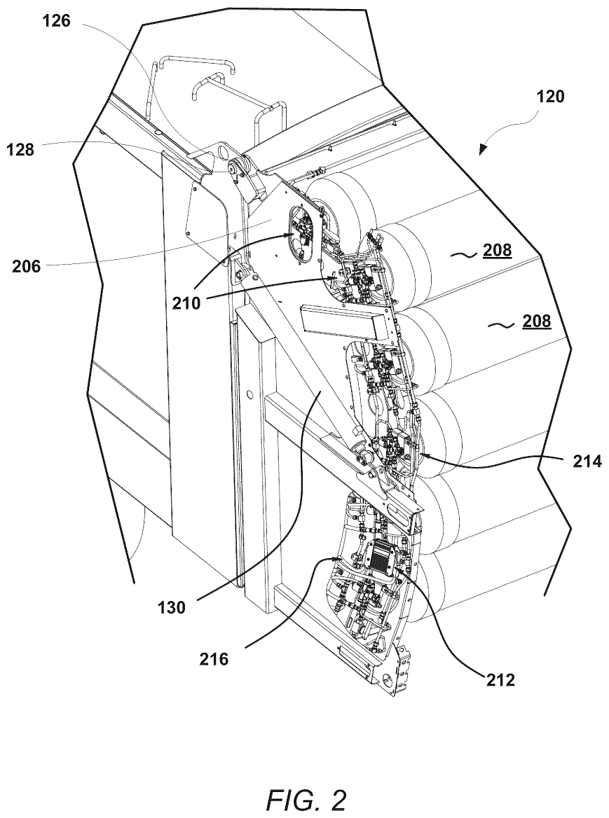

FIG. 2 shows a portion of a tailgate 120 including tanks of a fuel storage system. Tailgate 120 includes cover 140 (omitted for clarify in FIG. 2), framework 206 and a plurality of tanks 208. In some implementations, tanks are compressed natural gas (CNG) tanks. Tanks 208 are included in a fuel system that provides fuel for an engine of refuse collection vehicle 110. Portions of cover 140 surround the framework 206 and tanks 208 to prevent access to the tanks 208.

Each tank 208 includes a tank valve assembly 210 and can include one or more relief valves. Tank valve assemblies 210 can be coupled to a control unit 212, which includes a processor. Tank valve assemblies 210 can supply fuel from each of tanks 208 to an engine for refuse collection vehicle via fuel supply line 214. Control unit 212 can be coupled to sensors on various components of the fuel system by way of harness 216.

Relief valves can be attached to vent lines (e.g., vent tubes) that enable the compressed natural gas (CNG) to escape from the tanks. This may occur when the tanks encounter an increased pressure above a limit pressure. Also, this may occur when the tanks reach a designated temperature. Alternatively, the relief valves may do both. In some implementations, the control valves 210 can also include a relief valve portion coupled with a vent tube.

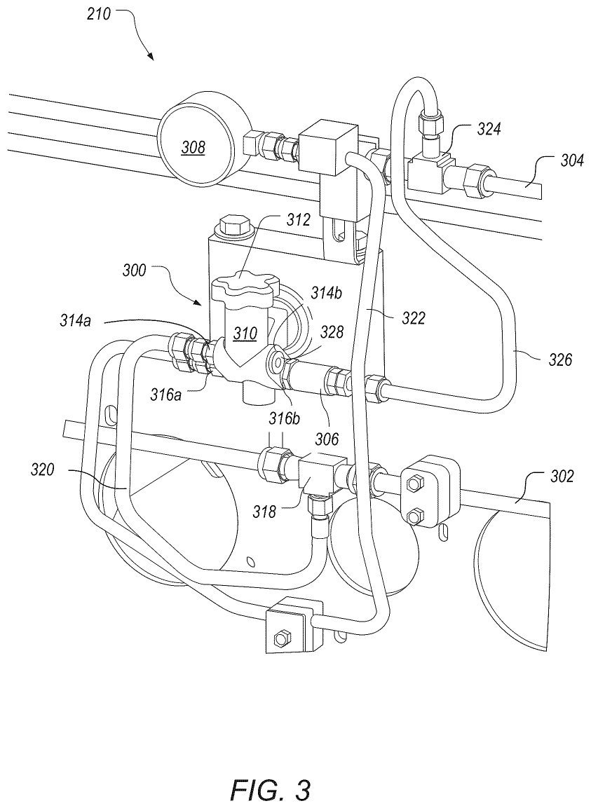

FIG. 3 illustrates a tank valve assembly on a fuel storage tank according to some implementations. Tank valve assembly 210 includes shutoff valve 300, main fuel line 302, vent line 304, pressure relief device 306, and pressure gauge 308. Shutoff valve 300 is coupled on a fuel tank (e.g., fuel tank 208 shown in FIG. 2).

Shutoff valve 300 includes valve body 310, manual shutoff handle 312, two fuel ports 314a, 314b (one on either side of valve body 310), and two live ports 316a, 316b (one on either side of valve body 310). Live ports 316a, 316b are below fuel ports 314a, 314b on valve body 310. In one example, fuel ports 314a, 314b and live ports 316a, 316b are 9/16 inch-18 UNF.

Fuel port 314a is connected to main fuel line 302 by way of tee fitting 318 and tube 320. Live port 316a is connected to pressure gauge by way of tube 322. Pressure relief device 306 is coupled to live port 316b. Pressure relief device 306 is connected to vent line 304 by way of tee fitting 324 and tube 326. Thus, pressure relief device 306 is interposed between live port 316b and vent line 304. Plug 328 is installed in fuel port 314b.

Manual shut-off handle 312 can be turned to open and close shutoff valve 300. When shutoff valve 300 is closed, flow is prevented between tank 208 and fuel ports 314a, 314b. Tank 208 remains, however, in fluid communication with live ports 316a, 316b regardless of whether shutoff valve is open or closed.

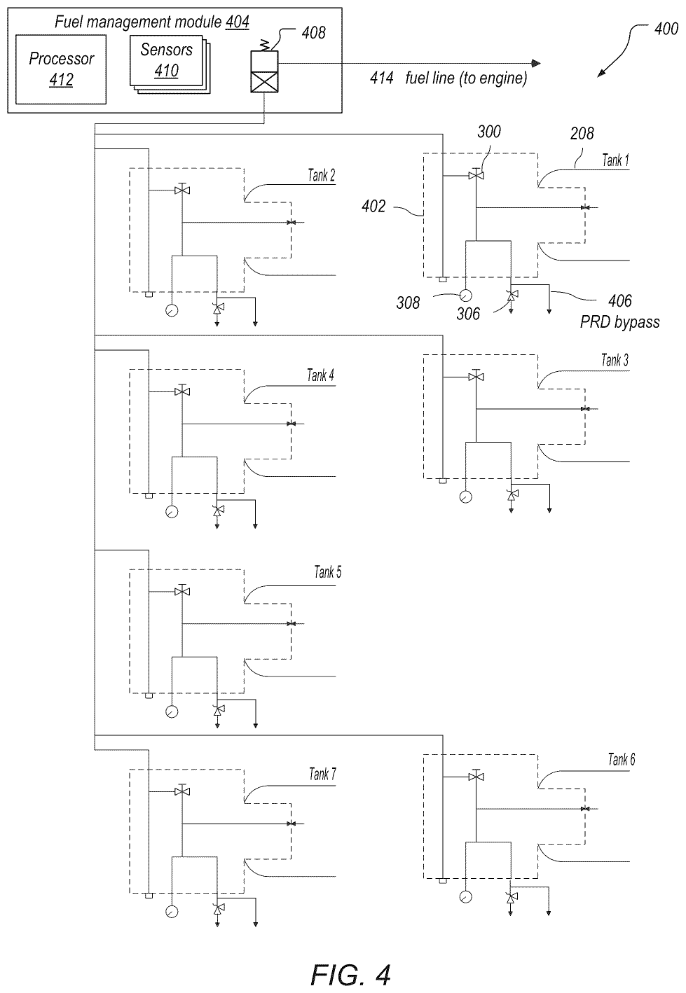

FIG. 4 is a schematic illustrating a fuel storage system including a pressure relief device bypass according to some implementations. Fuel storage system 400 includes tanks 208, tank valve assemblies 402, and fuel management module 404. Tank valve assemblies 402 can include components as described and shown in in FIG. 3. Thus, each of tank valve assemblies 402 can include shutoff valve 300, pressure relief device 306, and pressure gauge 308. Each valve tank assembly 402 includes a PRD bypass line 406. Each PRD bypass line 406 is connected to a live port of tank valve assembly 402 (for example, one of the live ports described above relative to FIG. 3). PRD bypass lines 406 can be connected to a pressure relief device bypass system that includes one or more PRD bypass devices. The PRD bypass device(s) can be operated to bypass one or more of pressure relief device 306.

Fuel management module 404 controls the provision of fuel from tanks 208 to the engine of the vehicle. Fuel management module 404 includes fuel solenoid valve 408, sensors 410, and processor 412. In some implementations, the processor is separate from a fuel management module (For example, the processor can be included in control unit 212 shown in FIG. 2). The processor can be communicatively coupled with sensors and solenoid valves via a wire harness or wirelessly.

Fuel solenoid valve 408 can be in a normally closed state. Thus, a signal is received by the fuel solenoid valve 408 to open the valve. When opened, the fuel in the tanks 208 is enabled to pass, into the fuel line 414 so that the fuel is supplied to the engine of the vehicle. Fuel solenoid valve 408 and sensors 410 of fuel management module 408 are electrically coupled with processor 412.

In some implementations, the processor sends signals, based on the ignition being on or off, to the fuel solenoid valve to activate and deactivate the fuel solenoid valve, which, in turn, opens and closes the fuel solenoid valve 408. The processor can receive information from sensors 410 and transmit the information to a display.

In use, when fuel solenoid valve 408 is activated (ignition on), the valve gate is opened enabling gas to exit tanks 208 into fuel line 414. Upon deactivation (ignition off) of the fuel solenoid valve enables the fuel in the fuel line to return into tanks 208. However, fuel cannot exit the tanks 208. Thus, fuel is enabled to return to the tanks 208 to equalize pressure in the system and in the tanks 208.

Manual shut-off valve 302 on a particular one of tanks 208 can be closed to terminate flow in or out of the tank 208. When this occurs, this overrides the fuel supply solenoid valve in fuel management module 404.

Each of pressure relief devices 306 includes a passageway into the tank 208. The pressure relief device 306 has a relief portion that is blocked by a stop. Upon exceeding a predetermined temperature, the stop melts. Thus, the CNG gas is free to escape to atmosphere through the vent lines. This enables the fuel within the tank 208 to escape through the relief portion into the vent lines 304, then to atmosphere.

When the ignition is turned on, a signal is sent from processor 412 to open the fuel solenoid valve 408. As the fuel solenoid valve 408 is opened, fuel (CNG) passes from the tank 208 into the fuel line 414 and, in turn, to the vehicle engine. In some implementations, all of the tanks 208 open as the ignition is turned on. Accordingly, an acceptable pressure can be present in the system and in each tank. Thus, the processor sends a signal to a display that displays the pressure in the tanks 208 indicating it is at an acceptable level. During optimal conditions, all tanks are open and an acceptable pressure is in each tank as well as in the system. Sensors 410 can sense the pressure in active live time conditions. Thus, processor 412 can sends signal to the display live, in real time, so that the user has the current status of the tanks 208 and the fuel line 414.

When the ignition is turned off, the fuel solenoid valves 408 is deactivated and the valve gate moves into a closed position. This terminates flow from the tanks 208 to the engine. The valves in the system may also allow the pressure to regulate and equalize in each tank that enables the gas, under pressure, in the system to return to tanks 208.

In the example shown in FIG. 4, fuel management module 404 includes, for illustrative purposes, a single solenoid valve. A fuel management system can, however, include more than one solenoid valve. In one implementation, a fuel management module includes a high-pressure manifold, low-pressure manifold, pressure regulators, valves (e.g., one or more solenoid valves), and a control unit. In some implementations, the fuel system includes a set of control valves, each controlling the supply of fuel from a single tank, or a set of two or more tanks. Other types of valves can be used to control the supply of fuel to an engine.

In the example shown in FIG. 4, a pressure relief device is provided for each tank. In other implementations, a pressure relief device can be shared among two more tanks. In some implementations, a pressure relief device and PRD bypass device can be shared among two more tanks. In certain implementations, a single tank can be equipped with two or more pressure relief devices, two or more PRD bypass devices, or both.

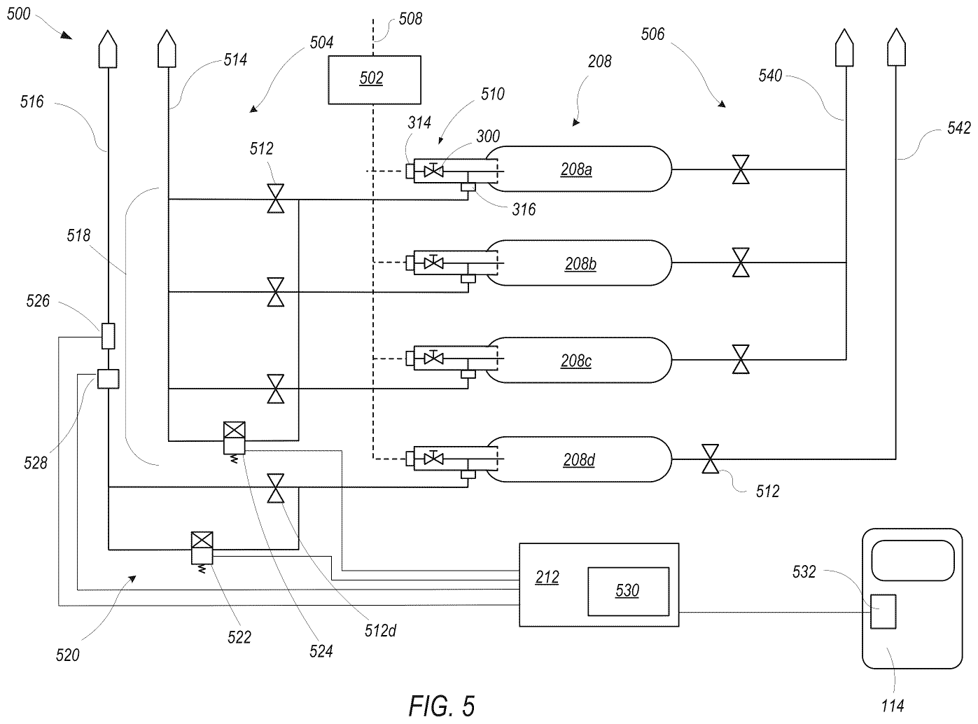

FIG. 5 illustrates a fuel storage system that provides for quick venting of multiple fuel tanks according to some implementations. Fuel storage system 500 can be installed in a refuse collection vehicle, such as refuse collection vehicle 110 shown in FIG. 1. Fuel storage system 500 includes tanks 208 (separately indicated for illustrative purposes as 208a, 208b, 208c, and 208d), fuel management system 502, street-side relief venting system 504, curb-side relief venting system 506, and control unit 212. Fuel line 508 can be coupled to the vehicle in which fuel storage system 500 is installed. A tank valve assembly 510 is coupled to each of tanks 208a, 208b, 208c, and 208d. Each of tank valve assemblies 510 is coupled to fuel management system 502. Tank valve assemblies each include shutoff valve 300, fuel port 314, and live port 316.

Street-side relief venting system 504 includes pressure relief devices 512, vent line 514, and vent line 516. Each of pressure relief devices 512 is coupled to at least one associated tank 208 via a live port 316 on the tank valve assembly 510. Tanks 208a, 208b, and 208c are part of upper tank group 518. Tanks 208a, 208b, and 208c are commonly fluidly coupled to vent line 514. Tank 208d is fluidly coupled to vent line 516. In this example, tank 208d may be the bottom-most tank in the fuel storage system (for example, the bottom tank 208 shown in FIG. 2). In some cases, pressure relief device 512d may be the most susceptible to activation if a thermal event happens on the vehicle.

Street-side relief venting system 504 includes pressure relief bypass system 520. Pressure relief bypass system 520 includes bypass solenoid valve 522, bypass solenoid valve 524, flow sensor 526, and pressure sensor 528. Bypass solenoid valve 522, bypass solenoid valve 524, flow sensor 526, and pressure sensor 528 are communicatively coupled to control unit 212. As illustrated in FIG. 5, a PRD bypass device can bypass a single PRD or multiple PRDs.

Bypass solenoid valve 522 is included in a line that bypasses the pressure relief device 408d associated with tank 208d. Bypass solenoid valve 424 is included in a line that bypasses pressure relief device 408 associated with the three tanks in upper tank group 518 (tanks 208a, 208b, and 208c). Bypass solenoid valve 422 and bypass solenoid valve 424 can be operated to bypass one or more of pressure relief devices 512.

Curb-side relief venting system 506 include pressure relief devices 512, vent line 540, and vent line 542. Each of pressure relief devices 512 is coupled to at least one associated tank 208 via a live port 316 on the tank. Tanks 208a, 208b, and 208c are commonly fluidly coupled to vent line 540. Tank 208d is fluidly coupled to vent line 542. Curb-side relief venting system 506 can provide additional mechanisms for pressure relief of fuel storage system 500.

Control unit 212 is communicatively coupled to control panel 532 in vehicle cab 114. In some implementations, an operator in vehicle cab 114 can control bypass solenoid valve 522, bypass solenoid valve 524, or both. In some implementations, control unit 212 controls valves in fuel management system 502.

In some implementations, the venting system includes fittings with tubes that connect a main vent line to each tank's live port. The bypass solenoid valve is connected between the live port and the main vent line.

In some implementations, bypass of one or more pressure relief devices in the relief venting system is triggered based on one or more conditions on the vehicle. In fuel storage system 400 shown in FIG. 5, bypass solenoid valve 522 can be opened to allow bypass of pressure relief device 512d. Bypass solenoid valve 524 can be opened to bypass pressure relief valves 512 in upper tank group 518.

In some examples, bypass solenoid valve 522 and bypass solenoid valve 524 are in a normally closed state. Processor 530 of control unit 212 can perform operations to energize one or both of bypass solenoid valve 522 and bypass solenoid valve 524 to allow such that gas in the tanks 208 is vented through vent line 514 and/or vent line 516.

In some implementations, pressure relief devices are bypassed based on data from sensors on the vehicle. In some implementations, pressure relief devices are bypassed based on data from a flow sensor, a pressure sensor, or both.

In some implementations, pressure relief devices on some tanks are bypassed in response to detecting that a pressure relief valve on another tank has been activated. In this case, the bypass can provide pressure relief before temperatures have increased enough to activate the pressure relief devices on those pressure relief devices. Bypassing pressure relief devices may reduce a risk of rupture of a tank and/or a risk of other damage or injury.

In one example, pressure sensor 526 senses a pressure above a pre-determined amount in vent line 514. From the measured pressure drop, the venting system can detect that pressure relief device 512d has activated, causing fuel in tank 208d to vent through vent line 412. The activation may be due to a thermal event in the location of tank 208d. In response to the pressure drop, processor 530 in control unit 212 can operate to open bypass solenoid valve 524. By opening bypass solenoid valve 524, all three of the pressure relief devices 408 in upper tank group 518 are bypassed, allowing venting from tanks 208a, 208b, and 208c through vent line 514.

In another example, flow sensor 528 senses a change in flow through vent line 514 above a predetermined amount. In some instances, the change in flow can be from zero flow to a positive flow, such as may occur when the pressure relief device activates. From the change in flow, the venting system can detect that pressure relief device 512d has activated, causing fuel in tank 208d to vent through vent line 516. In response to the change in flow, processor 530 in control unit 212 can operate to open bypass solenoid valve 524. By opening bypass solenoid valve 524, all three of the pressure relief devices 512 in upper tank group 518 are bypassed, allowing venting from tanks 208a, 208b, and 208c through vent line 514.

In another example, the system uses a pressure sensor drop to detect a thermal event. For instance, a drastic pressure drop upstream of pressure relief device may indicate that the pressure relief device has activated, signaling that a thermal event has occurred or is occurring near the location of the pressure relief device.

Sensors are, in some instances, placed only in select locations and/or the detect conditions on specific vent lines. In the example shown in FIG. 5, sensors to detect a thermal event are included on vent lines for only one of the fuel tanks. In some examples, sensors are placed in a location most likely to detect a thermal event on the vehicle. In some examples, sensors are placed to detect activation of the pressure relief device(s) that is most likely to activate in the case of the thermal event of the vehicle.

In some implementations, a sensor includes a methane detector. Information from the methane detector can be used to trigger activation of the PRD bypass system.

In some implementations, a venting system allows an operator to vent the CNG from the vehicle upon selection of a switch located remotely from the CNG. As such, the systems and methods disclosed herein allow an operator to vent CNG from a vehicle's fuel storage system in the event of an emergency and avoid the operator's having to rely on a thermal release valve system to vent the CNG. For example, control panel 532 can include a switch (mechanical, on a digital display screen) that allows an operator in vehicle cab 114 to activate bypass solenoid valve 522, bypass solenoid valve 524, or both. Control panel 532 can include a display that provides sensor information, PRD status, temperature status, and other information to the operator.

In some implementations, system 500 provides for emergency venting by a driver operating a switch in cab 114. In this case, a fuel system can be vented with only some of the pressure relief valves activating, or with none of the pressure relief valves activating.

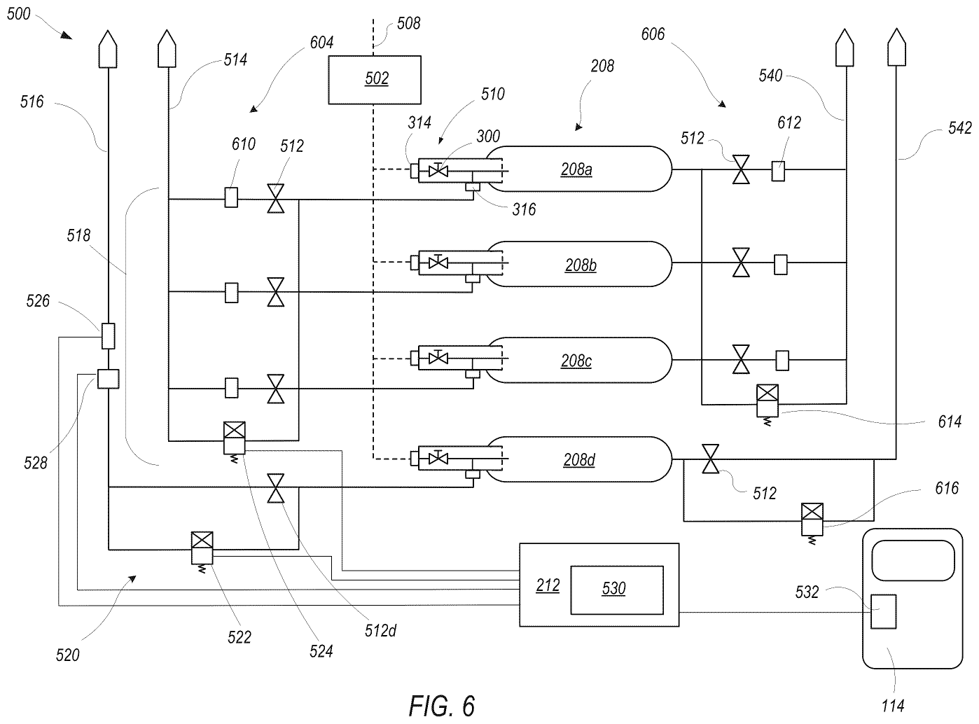

For illustrative purposes, the venting system in FIG. 5 includes sensors on only one of the vent lines and bypass valves on only the street-side relief venting system. In other implementations, sensors and bypass valves can be provided in other locations, or in additional locations. FIG. 6 illustrates a system that includes pressure relief bypass valves on curb-side and street side vent lines according to some implementations. Fuel storage system 600 includes tanks 208 (separately indicated for illustrative purposes as 208a, 208b, 208c, and 208d), fuel management system 502, street-side relief venting system 604, curb-side relief venting system 606, and control unit 212. Fuel line 508 can be coupled to the vehicle in which fuel storage system 400 is installed. A tank valve assembly 510 is coupled to each of tanks 208a, 208b, 208c, and 208d. Each of tank valve assemblies 510 is coupled to fuel management system 502. Street-side relief venting system 604 includes sensors 610. Each of sensors 610 can be communicatively coupled to control unit 212. Sensors 610 can include a pressure sensor, flow sensor, temperature sensor, or combinations thereof.

Curb-side relief venting system 606 includes sensors 612. Each of sensors 612 can be communicatively coupled to control unit 212. Sensors 612 can include a pressure sensor, flow sensor, temperature sensor, or combinations thereof. Curb-side relief venting system 606 includes bypass solenoid valve 614 and bypass solenoid valve 616.

Control unit 212 can be operated to open any or all of bypass solenoid valve 422, bypass solenoid valve 424, bypass solenoid valve 614, and bypass solenoid valve 616 in response to conditions on the vehicle. For example, one or both of bypass solenoid valve 614, and bypass solenoid valve 616 on the curb-side of the vehicle can be opened in response to detecting activation of one of the pressure relief devices on the street-side of the vehicle.

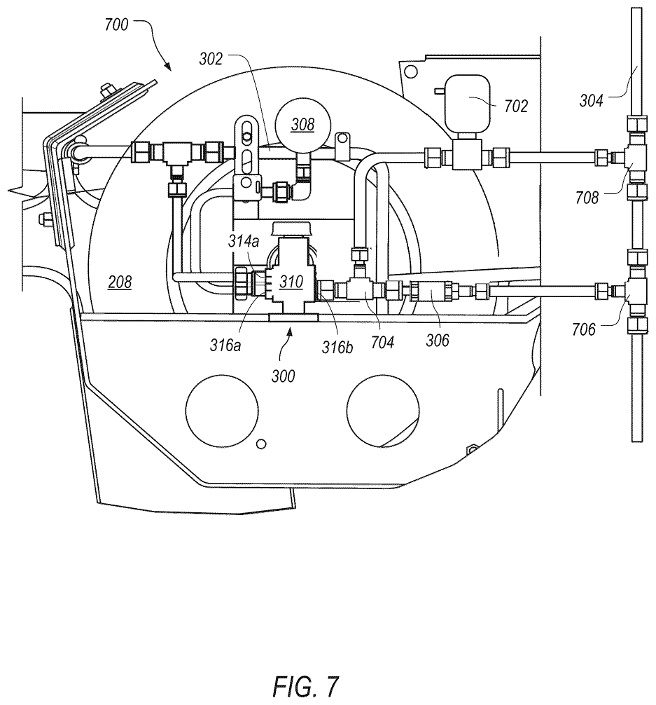

FIG. 7 illustrates a tank valve assembly that includes a PRD bypass valve according to some implementations. Tank valve assembly 700 includes shutoff valve 300, main fuel line 302, vent line 304, pressure relief device 306, pressure gauge 308, and PRD bypass device 702. Shutoff valve 300 is coupled on a fuel tank (e.g., fuel tank 208 shown in FIG. 2).

PRD bypass device 702 can be activated by a PRD bypass system, such as described above relative to FIG. PRD bypass device 702 can be, in some implementations, a solenoid valve.

Shutoff valve 302 includes valve body 310, a fuel port 314a, and two live ports 316a, 316b (one on either side of the valve body).

Fuel port 314a is connected to main fuel line 302 by way of tee fitting 318 and tube 320. Live port 316a is connected to pressure gauge by way of tube 322. Tee fitting 704 is coupled to live port 316b. One branch of tee fitting 704 is connected to pressure relief device 306. Another branch of tee fitting 704 is connected to PRD bypass device 702. Pressure relief device 306 is connected to vent line 304 by way of tee fitting 706. PRD bypass device 702 is connected to vent line 304 by way of tee fitting 708.

In the example shown in FIG. 7, PRD bypass is connected by tee fitting 704 to the same live port as pressure relief device 306 (live port 318b). A PRD bypass can, in other implementations, be connected to a different live port in fluid communication with a fuel tank. For example, a tee fitting could be connected to live port 318a, with one branch of the tee fitting being connected to pressure sensor 308 and another branch of the tee fitting being connected to the PRD bypass line. In certain implementations, the pressure sensor can be omitted from the tank valve assembly.

In the example shown in FIG. 7, a PRD device bypasses one pressure relief device. A PRD bypass device can, however, bypass any number of pressure relief devices on any number of tanks.

In the example shown in FIG. 7, both pressure relief device 306 and PRD bypass device 702 feed into the same vent line. In other implementations, vent lines downstream of the pressure relief devices and PRD bypass device can remain independent of one another.

In various implementations described above, bypass of PRDs is effected by way of a solenoid valve. In other implementations, a PRD bypass can be effected with other devices, such as a ball valve. Devices used to open a bypass line can be activated in various manners, including electrically, pneumatically, mechanically, or hydraulically.

In various implementations described above, the sensors used to detect a bypass include a pressure sensor and a flow sensor. Other types of sensors can be used to detect conditions that trigger venting. For example, a temperature sensor (e.g., thermocouple) can be used to detect a fire or other thermal event. The temperature sensor can be used to trigger bypass of pressure relief devices when, for example, the sensed temperature exceeds a predetermined threshold.

In various implementations described above, the fuel storage system is provided in a tailgate of a refuse collection vehicle. In other implementations, components of a fuel storage system, PRD bypass system, are provided in other locations on a vehicle. Examples of a location of the fuel storage system include the top of the body, a roof mount, the back of the cab, the front of the body, rail mount, or a combination of one or more of these.

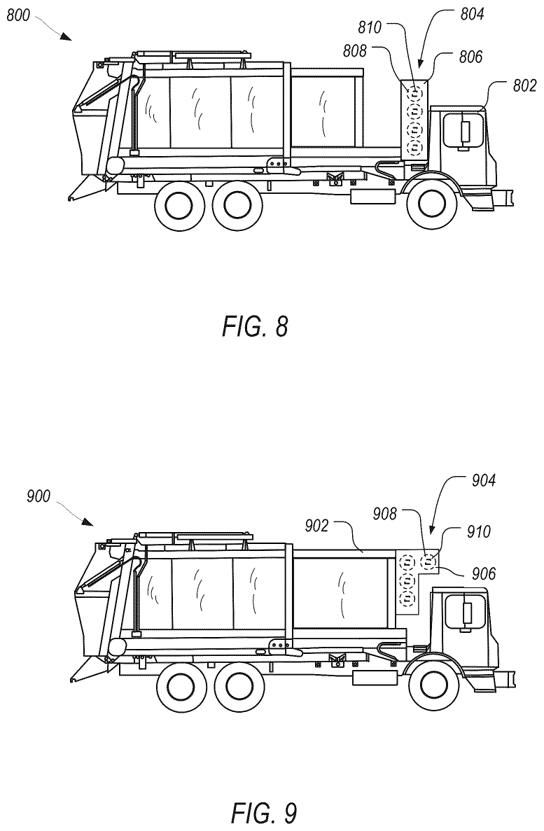

FIG. 8 illustrates a refuse collection vehicle with a fuel storage system with PRD bypass system mounted on a cab of a refuse collection vehicle. Refuse collection vehicle 800 includes cab 802 and fuel storage system 804. Fuel storage system 804 is coupled to cab 802. Fuel storage system 804 includes tank enclosure 806, fuel tanks 808, and PRD bypass system 810. PRD bypass system 810 is operable to bypass pressure relief devices in fuel storage system 804.

FIG. 9 illustrates a refuse collection vehicle with a fuel storage system with PRD bypass system mounted on the front of a body of a refuse collection vehicle. Fuel storage system 904 is coupled to body 902 at the front of body 902. Fuel storage system 904 includes tank enclosure 906, fuel tanks 908, and PRD bypass system 910. PRD bypass system 910 is operable to bypass pressure relief devices in fuel storage system 904.

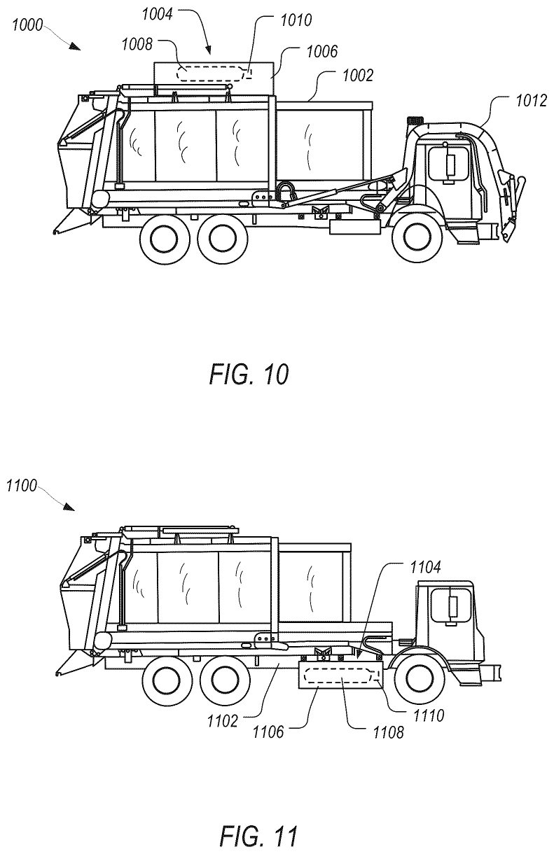

FIG. 10 illustrates a refuse collection vehicle with a fuel storage system with PRD bypass system mounted on the roof of the body of a refuse collection vehicle. Refuse collection vehicle 1000 includes body 1002 and fuel storage system 1004. Fuel storage system 1004 is coupled on the roof of body 1002. Fuel storage system 1004 includes tank enclosure 1006, fuel tanks 1008, and PRD bypass system 1010. PRD bypass system 1010 is operable to bypass pressure relief devices in fuel storage system 1004. Refuse collection vehicle 1000 includes intermediate container loading system 1012. Intermediate container loading system is operable to load refuse into body 1002 (e.g., by way of a hopper in front of tank enclosure 1006).

FIG. 11 illustrates a refuse collection vehicle with a fuel storage system with PRD bypass system mounted on a mount rail. Refuse collection vehicle 1100 includes mount rail 1102 and fuel storage system 1104. Fuel storage system 1104 is coupled to mount rail 1102. Fuel storage system 1104 includes tank enclosure 1106, fuel tanks 1108, and PRD bypass system 1110. PRD bypass system 1110 is operable to bypass pressure relief devices in fuel storage system 1104. In some implementations, a tank enclosure, a set of fuel tanks, and a PRD bypass system are mounted on both sides (e.g., on each of the left and right mount rails) of refuse collection vehicle 1100.

In various implementations described above, a fuel storage system includes four tanks, with a common bypass valve for three of the tanks and a dedicated bypass valve for one of the tanks. A fuel storage system can, however, include any number of tanks. Also, the tanks can be grouped in other manners (for example, two groups of three tanks, with each group having a bypass that is triggered by detection of a thermal event in the other group of tanks). In some implementations, a venting system is provided on only one side of a vehicle (e.g., only on curb-side or only on street-side).

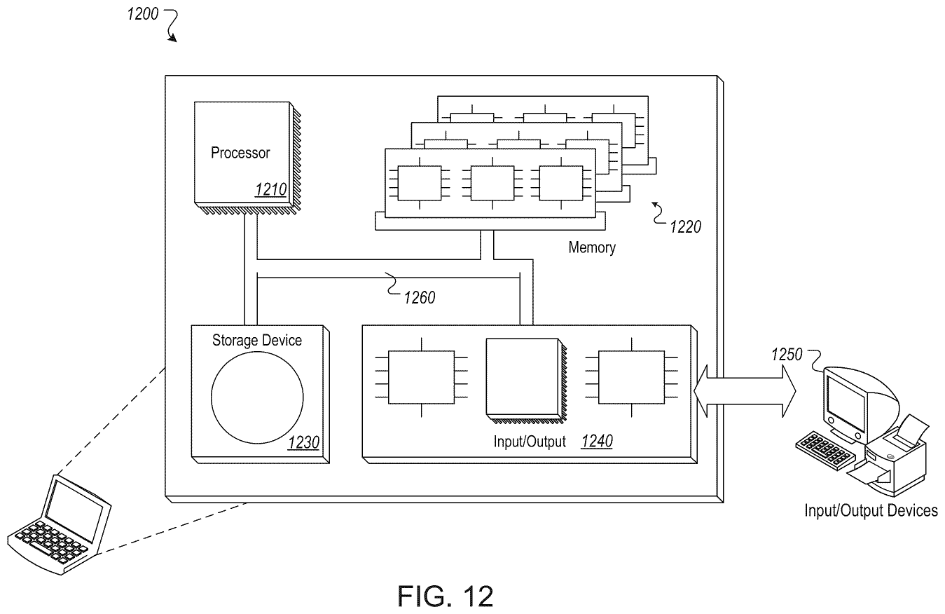

Control units and/or computing devices as described herein can include or use one or more computing systems. FIG. 12 depicts an example computing system, according to implementations of the present disclosure. The system 1200 may be used for any of the operations described with respect to the various implementations discussed herein. The system 1200 may include one or more processors 1210, a memory 1220, one or more storage devices 1230, and one or more input/output (I/O) devices 1250 controllable via one or more I/O interfaces 1240. The various components 1210, 1220, 1230, 1240, or 1250 may be interconnected via at least one system bus 1260, which may enable the transfer of data between the various modules and components of the system 1200.

The processor(s) 1210 may be configured to process instructions for execution within the system 1200. The processor(s) 1210 may include single-threaded processor(s), multi-threaded processor(s), or both. The processor(s) 1210 may be configured to process instructions stored in the memory 1220 or on the storage device(s) 1230. For example, the processor(s) 1210 may execute instructions for the various software module(s) described herein. The processor(s) 1210 may include hardware-based processor(s) each including one or more cores. The processor(s) 1210 may include general purpose processor(s), special purpose processor(s), or both.

The memory 1220 may store information within the system 1200. In some implementations, the memory 1220 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 1230 may be configured to provide (e.g., persistent) mass storage for the system 1200. In some implementations, the storage device(s) 1230 may include one or more computer-readable media. One or both of the memory 1220 or the storage device(s) 1230 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 1200. In some implementations, the CRSM may include a data store that provides storage of computer-readable instructions or other information in a non-transitory format. The CRSM may be incorporated into the system 1200 or may be external with respect to the system 1200. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 1210 and the memory 1220 may be supplemented by, or incorporated into, one or more application-specific integrated circuits (ASICs). The system 1200 may include one or more I/O devices 1250.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

As used herein, “pressure relief bypass” includes bypassing a pressure relief device. “Bypassing” a pressure relief device includes allowing gas to vent from a tank coupled to the pressure relief device without passing through the pressure relief device. Venting may occur through portions of the same lines that the pressure relief device is installed in, through lines separate from (e.g., in parallel with) those the pressure relief device is installed in, or through a combination of both.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

1. A method of protecting a refuse collection vehicle from damage, comprising:
detecting a condition associated with a thermal event on the refuse collection vehicle; and
in response to detecting the condition associated with the thermal event on the refuse collection vehicle, bypassing one or more pressure relief devices coupled to one or more fuel tanks of the refuse collection vehicle such that gas from at least one of the fuel tanks is vented from the at least one fuel tank.

2. The method of claim 1, wherein the gas vented from the at least one fuel tank comprises compressed natural gas (CNG).

3. The method of claim 1, wherein the condition comprises activation of a pressure relief device coupled to one or more of the one or more fuel tanks.

4. The method of claim 1, wherein the condition associated with the thermal event comprises venting from at least one of the one or more fuel tanks.

5. The method of claim 1, wherein the condition associated with the thermal event comprises a pressure drop in a vent line in fluid communication with at least one pressure relief device.

6. The method of claim 1, wherein the condition associated with the thermal event comprises a change in flow rate in a vent line in fluid communication with at least one pressure relief device.

7. The method of claim 1, wherein the condition associated with the thermal event comprises an increased risk of fire on the refuse collection vehicle.

8. The method of claim 1, wherein the thermal event comprises a fire on the refuse collection vehicle.

9. The method of claim 1, wherein bypassing the one or more pressure relief devices coupled to the one or more fuel tanks comprises bypassing two or more pressure relief valves each coupled to a different one of two or more fuel tanks.

10. The method of claim 1, wherein the condition associated with the thermal event comprises activation of a first pressure relief device coupled to a first one or more of the one or more fuel tanks, wherein bypassing the one or more pressure relief devices coupled of the one or more fuel tanks comprises bypassing one or more un-activated pressure relief devices coupled to the one or more fuel tanks.

11. The method of claim 10, wherein the first one of the fuel tanks is the bottom-most one of the fuel tanks in a group of two or more fuel tanks on the refuse collection vehicle.

12. The method of claim 10, wherein the first one of the fuel tanks is in the most hazardous location in a group of two or more tanks.

13. The method of claim 1, wherein bypassing one or more pressure relief devices coupled to one or more fuel tanks of the refuse collection vehicle comprises receiving a signal from an operator to open one or more bypass valves.

14. A fuel system for a refuse collection vehicle, comprising:
two or more fuel tanks coupled to the refuse collection vehicle;
two or more pressure relief devices, each of at least two of the pressure relief devices coupled to one or more of the two or more fuel tanks;
one or more pressure relief device bypass valves;
one or more sensors; and
a processor coupled to at least one of the one or more sensors and at least one of the one or more pressure relief device bypass valves, the processor configured to perform operations comprising:
detecting a condition associated with a thermal event on the refuse collection vehicle; and
in response to detecting the condition associated with a thermal event on the refuse collection vehicle, bypassing at least one of the one or more pressure relief devices such that gas from at least one of the fuel tanks is vented from the at least one fuel tank.

15. The fuel system of claim 14, wherein bypassing at least one of the one or more pressure relief devices comprises at least partially opening at least one of the pressure relief device bypass valves.

16. A fuel system for a refuse collection vehicle, comprising:
two or more fuel tanks coupled to the refuse collection vehicle;
two or more pressure relief devices, each of at least one of the pressure relief devices coupled to at least one of the two or more fuel tanks; and
one or more pressure relief device bypass valves fluidly coupled to at least one of the two or more fuel tanks, at least one of the pressure relief device bypass valves operable to at least partially open such that fuel is vented from at least one of the two or more fuel tanks.

17. The fuel system of claim 16, wherein at least one of the pressure relief devices is configured to provide pressure relief to at least two of the two or more fuel tanks.

18. The fuel system of claim 16, further comprising a vent line coupled to at least one of the pressure relief device bypass valves.

19. The fuel system of claim 16, wherein the two or more fuel tanks contains compressed natural gas (CNG).

20. The fuel system of claim 16, wherein the at least one pressure relief device bypass valve is configured to allow gas to bypass a pressure relief device coupled to each of at least one of the two or more fuel tanks.

21. The fuel system of claim 16, wherein the at least one pressure relief device bypass valve is configured to allow gas to bypass a pressure relief device coupled to each of at least two of the two or more fuel tanks.

22. The fuel system of claim 16, wherein the at least one pressure relief device bypass valve comprises a solenoid valve.

23. The fuel system of claim 16, further comprising a processor configured to at least partially open at least one of the pressure relief device bypass valves in response to detecting a thermal event on the vehicle.

24. The fuel system of claim 16, further comprising:
one or more sensors on the refuse collection vehicle; and
a processor communicatively coupled to at least one of the one or more sensors and at least one of the one or more pressure relief device bypass valves, the processor configured to perform operations comprising, in response to receiving data from the at least one sensor, opening at least one of the pressure relief device bypass valves.

25. The fuel system of claim 24, wherein:
the processor is configured to perform operations comprising, based at least in part on data from the at least one sensor, determine that at least one of the pressure relief device has activated, and
the at least one pressure relief device bypass valve is at least partially opened in response to determining that the least one pressure relief device has activated.

26. The fuel system of claim 24, wherein:
at least one of the sensors comprises a pressure sensor,
the processor is configured to, based at least in part on data from the pressure sensor, determine that a pressure drop meeting predetermined criteria has occurred in at least one line in the fuel system, and
wherein the at least one pressure relief device bypass valve is at least partially opened in response to determining that the pressure drop in the at least one line.

27. The fuel system of claim 24, wherein:
at least one of the sensors comprises a flow sensor,
the processor is configured to perform operations including:
based at least in part on data from the flow sensor, determining that at least one change in flow rate has occurred in at least one line in the fuel system, and
wherein the at least one pressure relief device bypass valve is at least partially opened in response to determining the at least one flow rate change in the at least one line.

28. The fuel system of claim 24, wherein:
the processor is configured to detect one or more conditions associated with a thermal event on the refuse collection vehicle, and
the at least one pressure relief device bypass valve is opened in response to detection of at least one of the one or more conditions associated with the thermal event.

29. The fuel system of claim 28, wherein the at least one condition comprises activation of at least one of the pressure relief devices.

30. The fuel system of claim 28, wherein the thermal event comprises a fire on the refuse collection vehicle.

31. The fuel system of claim 24, wherein the one or more sensors comprise a flow sensor configured to sense flow in one or more vent lines.

32. The fuel system of claim 24, wherein the one or more sensors comprise a pressure sensor.

33. The fuel system of claim 24, wherein the one or more sensors comprise a methane detector.

34. The fuel system of claim 24, wherein:
the two or more pressure relief devices comprise one or more curb-side pressure relief devices and one or more street-side pressure relief devices coupled to at least one of the two or more fuel tanks.

35. The fuel system of claim 24, further comprising a manual control device coupled to at least one of the one or more pressure relief device bypass valves, wherein the manual control device is operable by a user to open the at least one pressure relief device bypass valve such that fuel bypasses at least one of the one or more one or more pressure relief devices.

36. The fuel system of claim 16, further comprising a tank valve assembly coupled to at least one of the two or more tanks, the tank valve assembly comprising one or more live ports, wherein at least one of the pressure relief device bypass valves is fluidly coupled to at least one of the live ports of the tank valve assembly.

37. The fuel system of claim 16, further comprising a tank valve assembly coupled to at least one of the two or more tanks, the tank valve assembly comprising at shutoff valve comprising one or more live ports,
wherein at least one of the pressure relief device bypass valves is fluidly coupled to at least one of the live ports of the shutoff valve.

38. The fuel system of claim 16, further comprising a tank valve assembly coupled to at least one of the two or more tanks, the tank valve assembly comprising:
one or more live ports, and
one or more tee fittings,
wherein:
a first branch of the tee fitting is connected to at least one of the live ports, and
a second branch of the tee fitting is connected to at least one of the pressure relief device bypass valves.
